(19) United States
(12) Patent Application Publication
(10) Pub. No.: US 2012/0038949 A1
(43) Pub. Date: Feb. 16, 2012

(54) IMAGE PROCESSING APPARATUS AND METHOD OF THE SAME

(75) Inventor: Kazumasa TAKADA, Shizuoke-ken (JP)

(73) Assignees: Toshiba Tec Kabushiki Kaisha, Tokyo (JP); Kabushiki Kaisha Toshiba, Tokyo (JP)

(21) Appl. No.: 13/206,397

(22) Filed: Aug. 9, 2011

Related U.S. Application Data
(60) Provisional application No. 61/372,410, filed on Aug. 10, 2010.

(51) Int. Cl. G06F 3/12

(52) U.S. Cl. 358/1.15

(57) ABSTRACT

According to one embodiment, an image data bus transmits image data output from a first section to a second section. A controller adds data for inspection to the image data output from the first section, extracts the data for inspection from the image data received by the second section, and when the extracted data for inspection does not match with predetermined data for inspection, determines that the image data bus is abnormal.

### CROSS-REFERENCE TO RELATED APPLICATIONS

This application is based upon and claims the benefit of priority from U.S. provisional application 61/372,410, filed on Aug. 10, 2010, the entire contents of which are incorporated herein by reference.

### FIELD

Embodiments described herein relate generally to an image processing apparatus and a method of the same.

### BACKGROUND

An image processing apparatus such as a copying machine includes a scanning unit which optically scans and reads an image of an original document and outputs image data corresponding to the read image, an image processing section which processes the image data output from the scanning unit, a processing unit which transfers an image corresponding to the image data output from the image processing section onto an image forming medium such as a paper sheet, and an image data bus which transmits the image data between the scanning unit, the image processing section, and the processing unit.

When an abnormality occurs in the image data bus, the image data cannot be transmitted in an appropriate state. In this case, image formation quality is degraded.

### BRIEF DESCRIPTION OF THE DRAWINGS

FIG. 1 is a diagram showing the overall configuration of each embodiment.

FIG. 2 is a diagram showing main parts of an exposure unit in each embodiment.

FIG. 3 is a block diagram showing a control circuit of each embodiment.

FIG. 4 is a timing chart showing image data before void adjustment and after void adjustment in each embodiment.

FIG. 5 is a diagram showing a basic format of each piece of pixel data included in the image data of FIG. 4.

FIG. 6 is a diagram showing a basic format of each piece of line data included in the image data of FIG. 4.

FIG. 7 is a flowchart showing control of a controller according to a first embodiment.

FIG. 8 is a diagram showing an addition position of data for inspection according to the first embodiment.

FIG. 9 is a diagram showing an addition position of data for inspection according to a second embodiment.

FIG. 10 is a diagram showing an addition position of data for inspection according to a third embodiment.

FIG. 11 is a diagram specifically showing the addition position of the data for inspection of FIG. 10.

FIG. 12 is a diagram showing an addition position of data for inspection according to a fourth embodiment.

FIG. 13 is a diagram specifically showing the addition position of the data for inspection of FIG. 12.

FIG. 14 is a diagram showing an addition position of line data for inspection according to a fifth embodiment.

FIG. 15 is a diagram showing a plurality of pieces of data for inspection included in line data for inspection of FIG. 12.

### DETAILED DESCRIPTION

In general, according to one embodiment, an image processing apparatus includes: a first section which outputs image data; an image data bus which transmits the image data output from the first section; a second section which receives the image data transmitted by the image data bus; and a controller which adds data for inspection to the image data output from the first section, extracts the data for inspection from the image data received by the second section, and when the extracted data for inspection does not match with predetermined data for inspection, determines that the image data bus is abnormal.

[1] A first embodiment will be described with reference to the drawings.

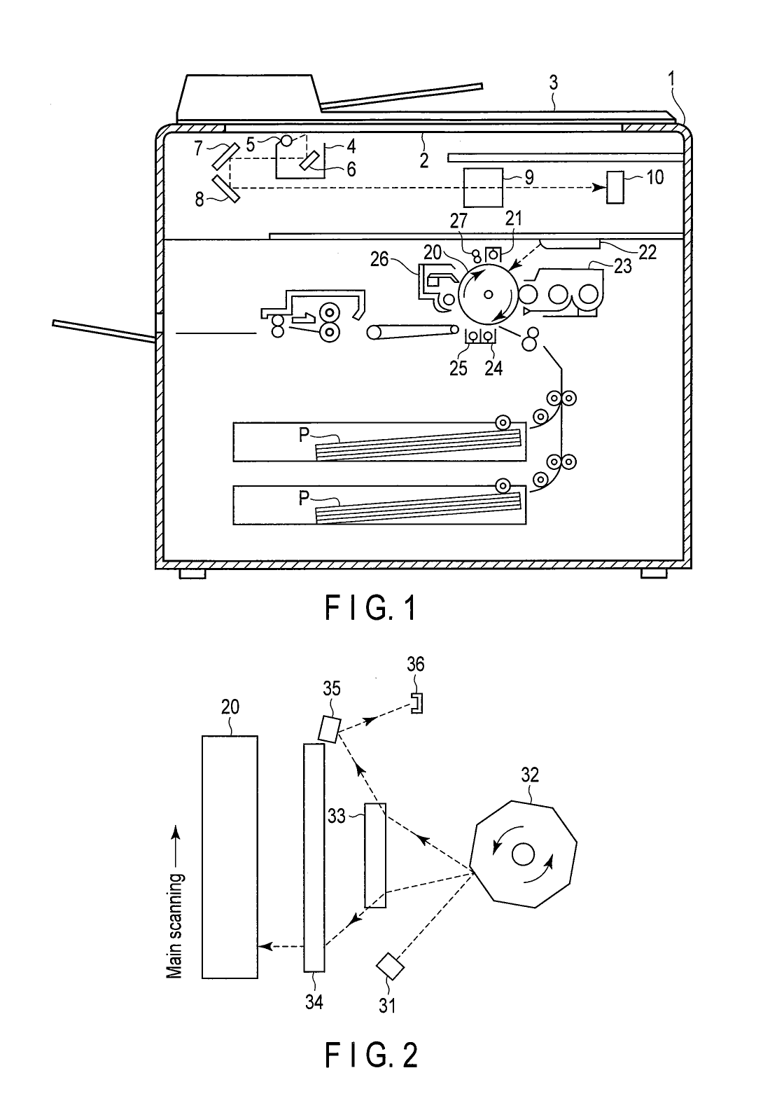

As shown in FIG. 1, a platen (glass plate) 2 is disposed at the upper portion of a main body 1. A cover 3 is disposed on the platen 2. A carriage 4 is disposed on the lower surface side of the platen 2, and an exposure lamp 5 is disposed in the carriage 4. The carriage 4 reciprocates along the lower surface of the platen 2. As the exposure lamp 5 is lit while the carriage 4 moves forward, an original document on the platen 2 is exposed. By the exposure, an image of the original document is optically read. The read image is projected onto a CCD 10 via reflex mirrors 6, 7, and 8 and a lens block 9.

In the periphery of a photoconductive drum 20 which is an image holding body, a charging unit 21, an exposure unit 22, a developing unit 23, a transfer unit 24, a peeling unit 25, a cleaner 26, and a neutralizing unit 27 are disposed in this order.

Main parts of the exposure unit 22 are shown in FIG. 2. A laser beam emitted by a laser unit 31 for image formation illuminates a rotation-type polygon mirror 32. The polygon mirror 32 reflects the laser beam emitted from the laser unit 31 toward the photoconductive drum 20. The reflected laser beam illuminates the photoconductive drum 20 via lenses 33 and 34. By the rotation and reflection of the polygon mirror 32, main scanning is performed on the photoconductive drum 20 along the axial direction of the photoconductive drum 20, and the main scanning is repeated along with the rotation of the photoconductive drum 20. The repetition of the main scanning is sub-scanning. By the main scanning and the sub-scanning, an electrostatic latent image is formed on the photoconductive drum 20.

The laser beam emitted from the laser unit 31 illuminates a laser detection unit 36 via the polygon mirror 32, the lens 33, and a mirror 35 at the start of the main scanning. The laser detection unit 36 detects the illuminating laser beam as a reference position of the main scanning.

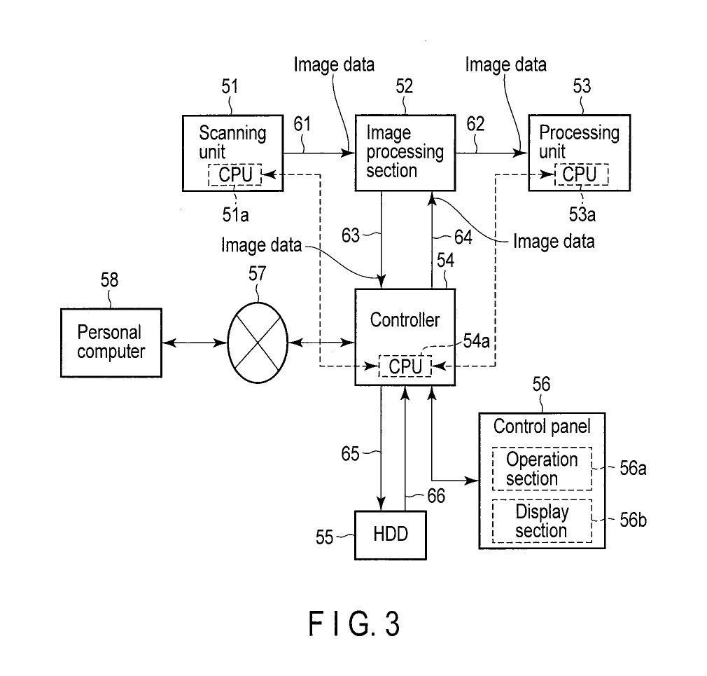

A control circuit is shown in FIG. 3.

A scanning unit 51 includes the configurations from the platen 2 to the CCD 10 and a CPU 51a, and converts and outputs an image signal output from the CCD 10 into image data by a binarization process. An image data bus 61 transmits the image data output from the scanning unit 51 to an image processing section 52.

The image processing section 52 includes an ASIC, receives the image data transmitted by the image data bus 61, and appropriately processes and outputs the received image data. An image data bus 62 transmits the image data output from the image processing section 52 to a processing unit 53. An image data bus 63 transmits the image data in the image processing section 52 to a controller 54. An image data bus 64 transmits the image data subjected to a software process of the controller 54 to the image processing section 52.

The processing unit 53 includes the configurations from the photoconductive drum 11 to the neutralizing unit 27 and a CPU 53a, and by performing the main scanning and sub-scanning on the photoconductive drum 20 on the basis of the image data received from the image data bus 62, transfers (prints) an image corresponding to the image data received from the image data bus 62 onto a paper sheet which is an image forming medium.

In addition, a data size of the image data is greater than the size of data to be transferred onto the paper sheet both in the main scanning direction and the sub-scanning direction. The processing unit 53 sets a first void area B1 as a non-image formation area at the front end of the main scanning, and sets a second void area B2 as a non-image formation area at the rear end of the main scanning. In addition, the processing unit 53 sets a third void area B3 as a non-image formation area at the front end of the sub-scanning, and sets a four void area B4 as a non-image formation area at the rear end of the sub-scanning. The void areas B1, B2, B3, and B4 are also referred to as whitened areas (“null” areas). In addition, a process of setting the void areas B1, B2, B3, and B4 is also referred to as void adjustment.

The controller 54 includes a CPU 54a connected to the CPUs 51a and 53a via signal lines and has (1) to (5) control sections as main functions as follows:

(1) The first control section that adds data C for inspection to the image data output from the image processing section 52. Specifically, the first control section replaces, with the data C for inspection, image data of an area corresponding to any of the first and second void areas B1 and B2, from the image data output from the image processing section 52.

(2) The second control section that extracts the data C for inspection from the image data received by the processing unit 53.

(3) The third control section that compares the extracted data C for inspection to predetermined data Cs for inspection.

(4) The fourth control section that, when the comparison result does not match, determines that the image data bus 62 is abnormal.

(5) The fifth control section that, when it is determined that the image data bus 62 is abnormal, the details of the abnormality is notified by a display of a display section 56b of a control panel 56.

A hard disk drive 55 for image data storage is connected to the controller 54 via image data buses 65 and 66, and the control panel 56 is also connected thereto. The control panel 56 has an operation section 56a, as well as the display section 56b. In addition, a personal computer 58 for users is connected to the controller 54 via a communication network 57.

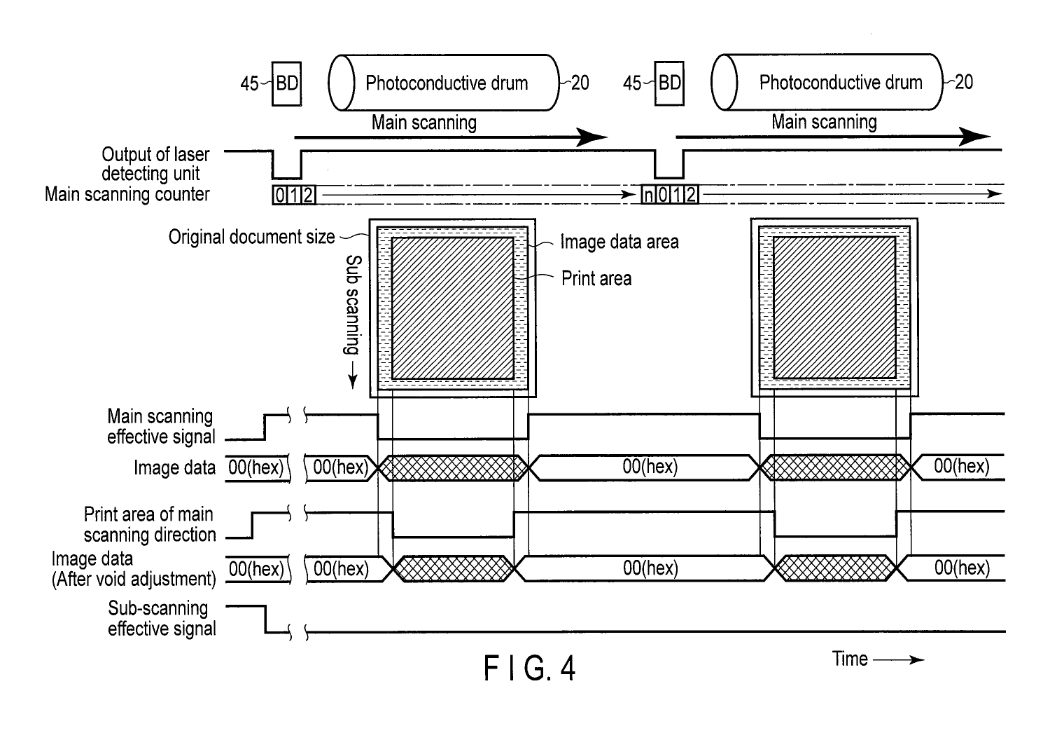

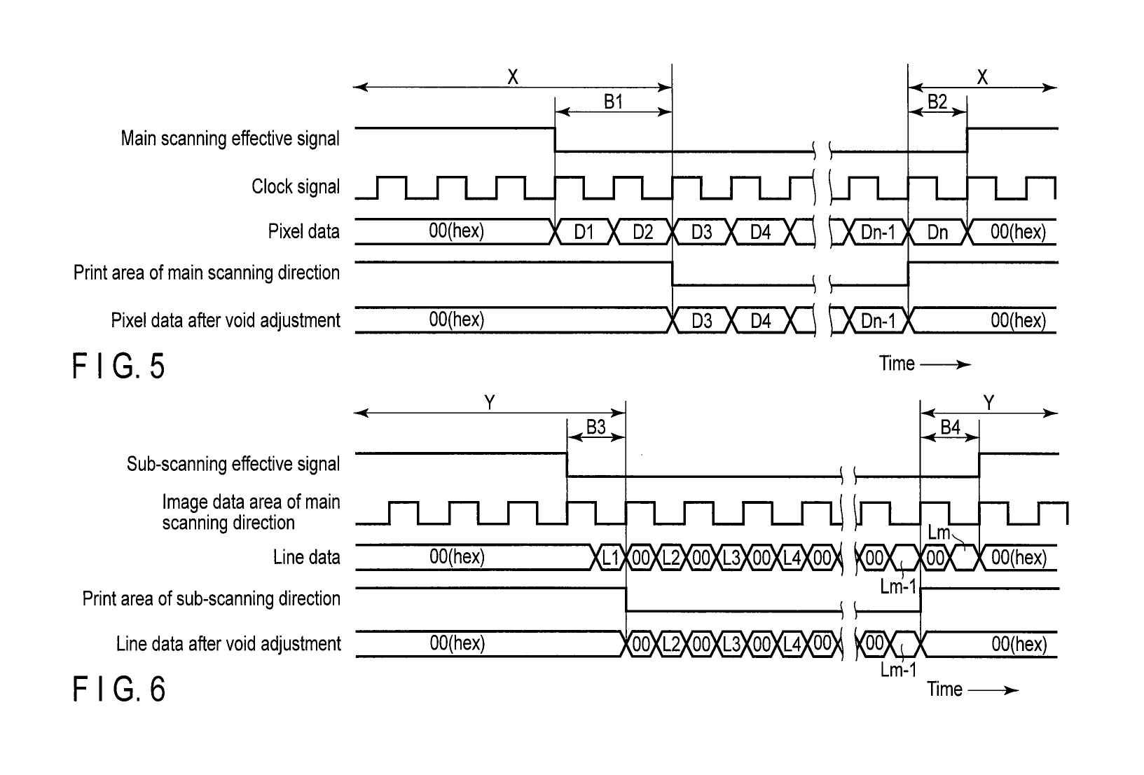

The image data before void adjustment and after void adjustment is shown in the timing chart of FIG. 4. Image data for a page includes, as shown in FIG. 5, a plurality of pieces of pixel data D1, D2, . . . Dn lined up along the main scanning direction. The pixel data D1, D2, . . . Dn is, for example, 8-bit data. In addition, the image data for a page includes, as shown in FIG. 6, a plurality of pieces of line data L1, L2, . . . Lm lined up in the sub-scanning direction. Each piece of the line data L1, L2, . . . Lm is a set of the pixel data D1, D2, Dn lined up along the main scanning direction. The pixel data D1, D2, . . . Dn and the line data L1, L2, . . . Lm of FIGS. 5 and 6 are basic formats.

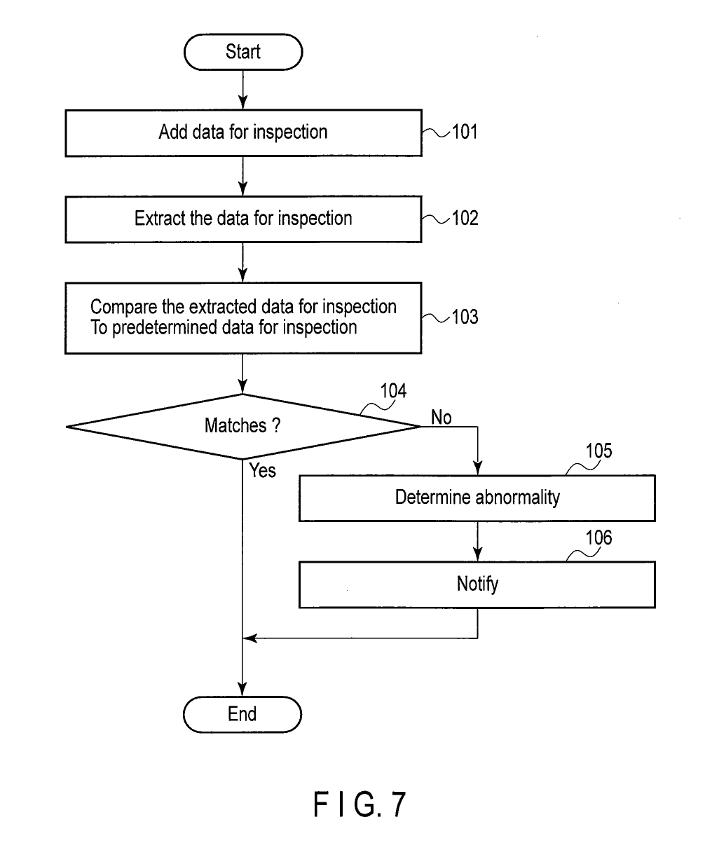

The controller 54 performs control shown in FIG. 7.

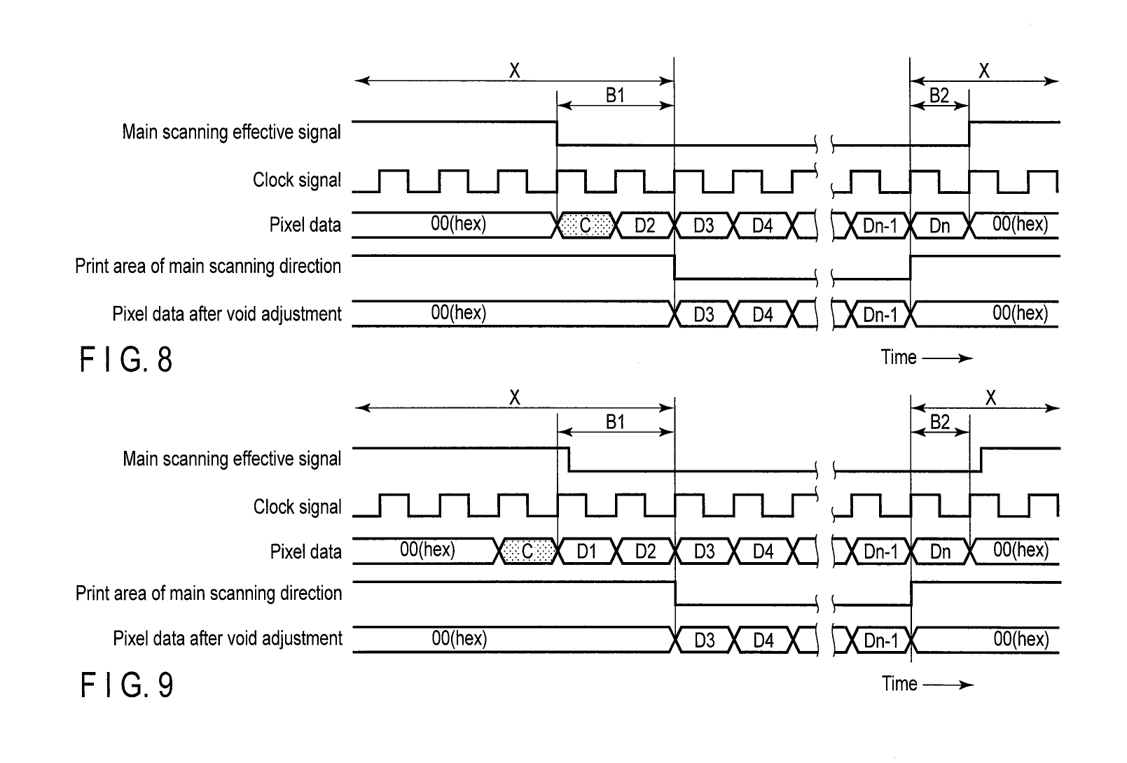

First, the controller 54 adds the data C for inspection to the image output from the image processing section 52 (Act 101). The data C for inspection is 8-bit data having an appropriate combination of “1” and “0”, and has a data capacity which is the same as a data capacity of each piece of the pixel data D1, D2, . . . Dn. Specifically, as shown in FIG. 8, the controller 54 replaces, with the data C for inspection, the single piece of pixel data D1 of an area corresponding to the first void area B1 from among the pieces of pixel data D1, D2, . . . Dn of the image data output from the image processing section 52.

In addition, from among the pieces of pixel data D1, D2, . . . Dn of the image data output from the image processing section 52, each of the two pieces of pixel data D1 and D2 of an area corresponding to the first void area B1 may be replaced with the data C for inspection. From among the pieces of pixel data D1, D2, . . . Dn of the image data output from the image processing section 52, the single piece of pixel data Dn of an area corresponding to the second void area B2 may be replaced with the data C for inspection.

The controller 54 extracts the data C for inspection from the image data received by the processing unit 53 (Act 102). The controller 54 compares the extracted data C for inspection to the predetermined data Cs for inspection (Act 103). When the comparison result does not match (No in Act 104), the controller 54 determines that the image data bus 62 is abnormal (Act 105), and provides notification of the details of the abnormality by the display of the display section 56b of the control panel 56 (Act 106). The controller 54 performs the process of Acts 102 to 106 in a period in which a sub-scanning effective signal shown in FIG. 6 is active (“1”). This period is also a processing period for determination of print end, void adjustment, and the like.

The user can be notified of the abnormality of the image data bus 62 by seeing the display of the display section 56b. In addition, the user can request a repair.

While the main body 1 is operated, existence of the abnormality of the image data bus 62 is always monitored by the controller 54. Therefore, a special device for detecting the abnormality of the image data bus 62 is unnecessary. A detection operation by the user or maintenance personnel is also unnecessary.

Since the data C for inspection exists in the first or second void area B1 or B2, image formation by the processing unit 53 is not affected.

[2] A second embodiment will be described.

From the image data in the main scanning direction, image data corresponding to an area between the first and second void areas B1 and B2 is effective image data for image formation. On both sides of the effective image data for image formation, unnecessary areas X for image formation exist. The areas X include the first and second void areas B1 and B2. In addition, from the image data in the sub-scanning direction, image data corresponding to an area between the third and fourth void areas B3 and B4 is effective image data for image formation. On both sides of the effective image data for image formation, unnecessary areas Y for image formation exist. The areas Y include the third and fourth void areas B3 and B4.

The position of the data C for inspection may be in any of the unnecessary areas X and Y for image formation. That is, as shown in FIG. 9, the controller 54 replaces, with the data C for inspection, a single pixel of the image data of an area corresponding to the outer area of the first void area B1 from the image data output from the image processing section 52.

In addition, a single pixel of the image data of an area corresponding to the outer area of the second void area B2 from the image data output from the image processing section 52 may be replaced with the data C for inspection.

Other configurations and control are the same as those of the first embodiment. Therefore, description thereof will be omitted.

[3] A third embodiment will be described.

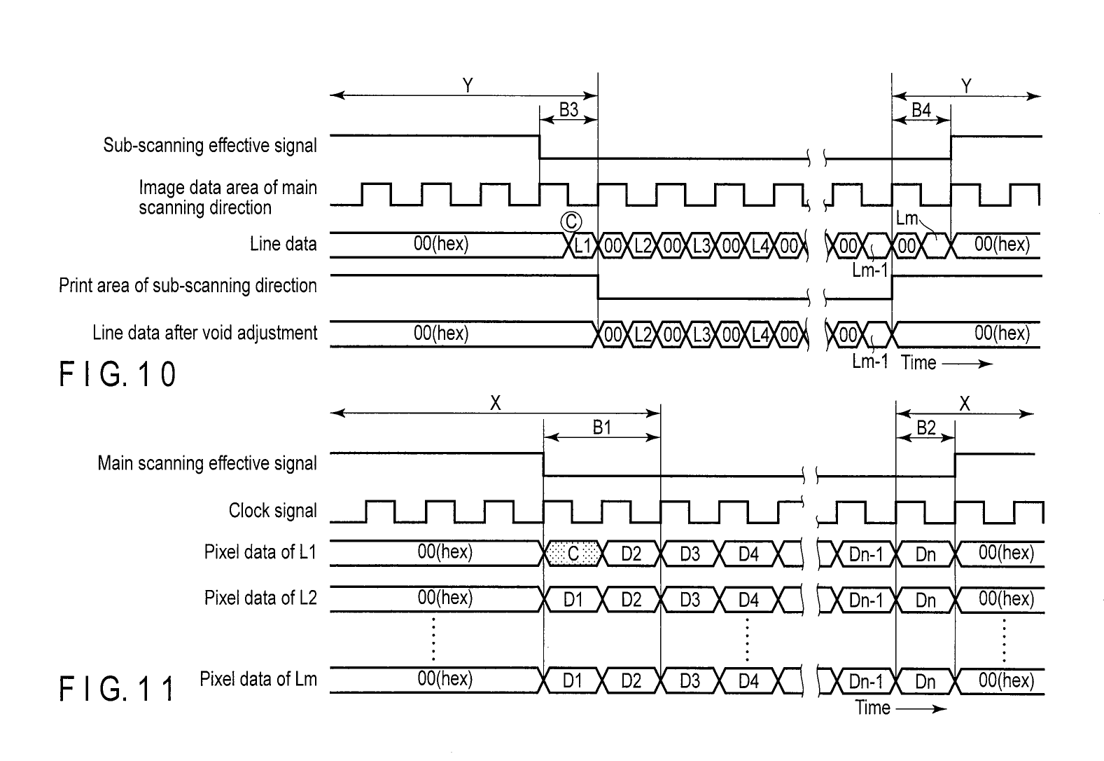

The position of the data C for inspection may be in any of the unnecessary areas X and Y for image formation. That is, as shown in FIG. 10, the controller 54 replaces, with the data C for inspection, a single pixel of the line data L1 of an area corresponding to the third void area B3 from the image data output from the image processing section 52. Specifically, as shown in FIG. 11, the pixel data D1 of the line data L1 is replaced with the data C for inspection. The replacement position may be in plural of the pixel data D1, D2, . . . Dn of a line data.

In addition, a single pixel or two pixels of the line data L1 of an area corresponding to the fourth void area B4 from the image data output from the image processing section 52 may be replaced with the data C for inspection.

Other configurations and control are the same as those of the first embodiment. Therefore, description thereof will be omitted.

[4] A fourth embodiment will be described.

A plurality of pieces of data for inspection C1, C2, . . . Cm which have different contents from each other may be used. Each of the pieces of data for inspection C1, C2, . . . Cm has a data capacity (8 bits) which is the same as the data capacity of each of the pieces of pixel data D1, D2, . . . Dn.

As an example of the data for inspection C1, C2, . . . Cm, for example, 12 pieces of 8-bit data “00h”, “01h”, “02h”, “04h”, “08h”, “10h”, “20h”, “40h”, “80h”, “55h”. “AAh”, and “FFh” which have different combinations of “1” and “0” are used.

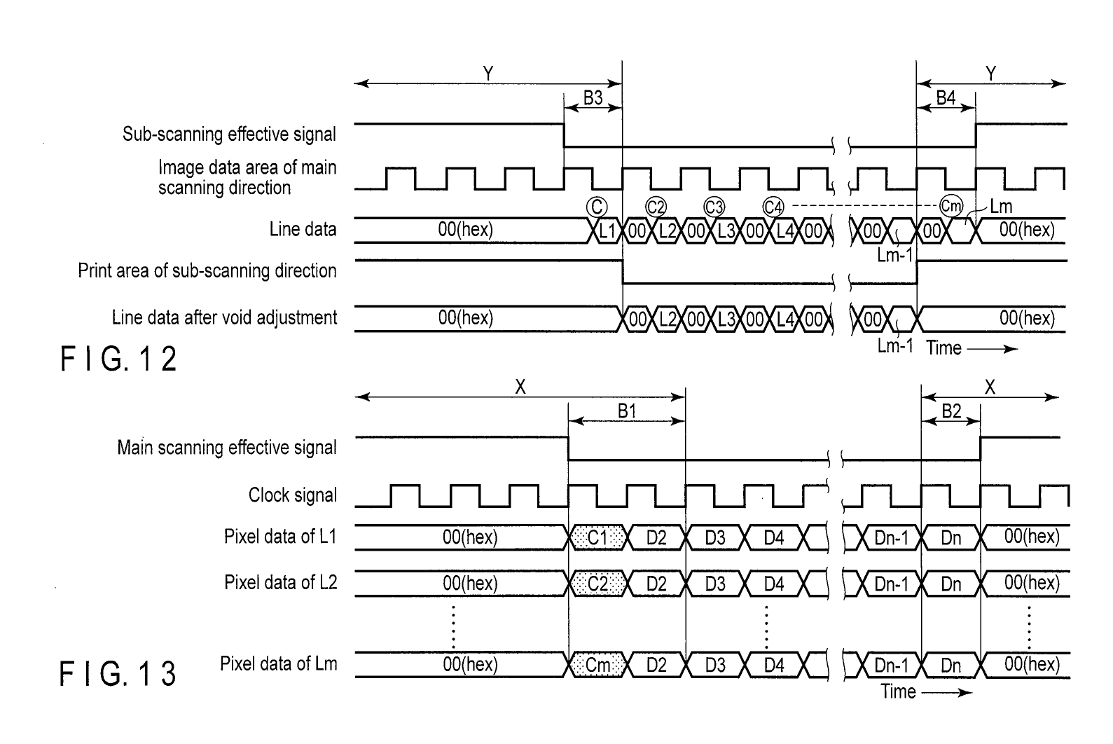

As shown in FIGS. 12 and 13, the controller 54 replaces, with the data for inspection C1, C2, . . . Cm, the pixel data D1 of each of the pieces of line data L1, L2, . . . Lm from the image data output from the image processing section 52. When the number of pieces of data for inspection C1, C2, . . . Cm is 12, the pixel data D1 of the 12 pieces of line data L1, L2, . . . become contrasts of replacement.

In addition, the controller 54 extracts the data for inspection C1, C2, . . . Cm from the image data received by the processing unit 53, and when the contents and order of the extracted data for inspection C1, C2, . . . Cm do not match with the contents and order of the predetermined data for inspection C1, C2, . . . Cm, determines that the image data bus 62 is abnormal.

Using the plurality of pieces of data for inspection C1, C2, . . . Cm, accuracy of the detection of the abnormality of the image data bus 62 is enhanced.

For example, based on the contents of combination of two or more data for inspection that do not match from among the 12 pieces of data for inspection C1, C2, . . . Cm, it is accurately detectable any of each bit of the image data bus 62 have abnormalities.

In addition, from the image data output from the image processing section 52, the two pieces of image data D1 and D2 of each of the pieces of line data L1, L2, . . . Lm may be replaced with the data for inspection C1, C2, . . . Cm. From the image data output from the image processing section 52, the single piece of pixel data Dn of each of the pieces of line data L1, L2, . . . Lm may be replaced with the data for inspection C1, C2, . . . Cm.

Since the data for inspection C1, C2, . . . Cm exists in the first or second void areas B1 or B2, image formation by the processing unit 53 is not affected.

Other configurations, control, and effects are the same as those of the first embodiment. Therefore, description thereof will be omitted.

[5] A fifth embodiment will be described.

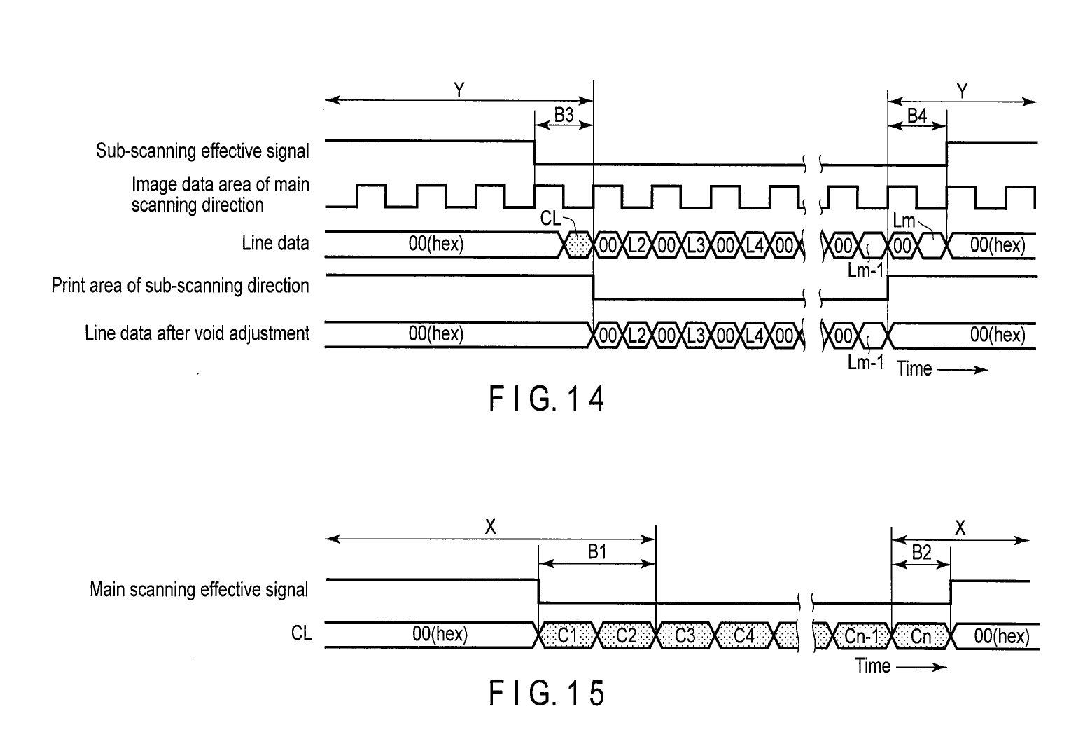

The position of the data for inspection C1, C2, . . . Cm may be in any of the unnecessary areas X and Y for image formation. That is, as shown in FIG. 14, the controller 54 replaces, with line data CL for inspection, the line data L1 of an area corresponding to the third void area B3 from the image data output from the image processing section 52. The line data CP for inspection is, as shown in FIG. 15, a set of data for inspection C1, C2, . . . Cn. The data for inspection C1, C2, . . . Cn have different contents from each other.

In addition, the line data Lm of an area corresponding to the fourth void area B4 from the image data output from the image processing section 52 may be replaced with the line data CL for inspection.

Since the data for inspection C1, C2, . . . Cn exist in the third or fourth void area B3 or B4, image formation by the processing unit 53 is not affected.

Other configurations, control, and effects are the same as those of the fourth embodiment. Therefore, description thereof will be omitted.

[6] In addition, in each of the embodiments, the image data bus 62 between the image processing section 52 and the processing unit 53 is described as an object of abnormality detection; however, the image data bus 61 between the scanning unit 51 and the image processing section 52 may also be an object of abnormality detection. The image data buses 63 and 64 between the image processing section 52 and the controller 54 may also be an object of abnormality detection. The image data buses 65 and 66 between the controller 54 and the hard disk drive 55 may also be an object of abnormality detection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changed in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a first section which outputs image data;
an image data bus which transmits the image data output from the first section;
a second section which receives the image data transmitted by the image data bus; and
a controller which adds data for inspection to the image data output from the first section, extracts the data for inspection from the image data received by the second section, and when the extracted data for inspection does not match with predetermined data for inspection, determines that the image data bus is abnormal.

2. The apparatus of claim 1, wherein, when the controller determines that the image data bus is abnormal, the controller provides notification of the details of the abnormality.

3. The apparatus of claim 1, wherein the controller replaces image data of an area which is unnecessary for image formation, from the image data output from the first section, with the data for inspection.

4. The apparatus of claim 1,
wherein the first section is an image processing section which processes the image data, and
the second section is a processing unit which includes an image holding body, forms an image corresponding to the image data received from the image data bus on the image holding body by performing main scanning and sub-scanning on the image holding body according to the image data received from the image data bus, and transfers the image on the image holding body onto an image forming medium.

5. The apparatus of claim 4, wherein the processing unit sets first and second void areas as non-image formation areas at a front end and a rear end of the main scanning, and sets third and fourth void areas as non-image formation areas at a front end and a rear end of the sub-scanning.

6. The apparatus of claim 5, wherein the controller replaces image data of an area corresponding to any of the void areas from the image data output from the image processing section, with the data for inspection.

7. The apparatus of claim 5, wherein the image data includes a plurality of pieces of pixel data lined up along a direction of the main scanning and includes a plurality of pieces of line data lined up along a direction of the sub-scanning, the pieces of line data being a set of the pieces of pixel data lined up along the direction of the main scanning.

8. The apparatus of claim 7,
wherein the data for inspection has a data capacity which is the same as a data capacity of the pixel data, and
the controller replaces at least one piece of pixel data of the area corresponding to any of the first and second void areas from among the pieces of pixel data of the image data output from the image processing section, with the data for inspection.

9. The apparatus of claim 7,
wherein the data for inspection has a data capacity which is the same as a data capacity of the pixel data, and
the controller replaces at least one piece of pixel data of at least one piece of line data of the area corresponding to any of the third and fourth void areas from among the pieces of line data of the image data output from the image processing section, with the data for inspection.

10. The apparatus of claim 7,
wherein the data for inspection is a plurality of pieces of data for inspection, and the pieces of data for inspection have a data capacity which is the same as a data capacity of the pixel data and have different contents from each other, and
the controller replaces each piece of pixel data of at least one piece of line data of the area corresponding to any of the third and fourth void areas from among the pieces of line data of the image data output from the image processing section, with the data for inspection.

11. The apparatus of claim 1,
wherein the first section is a scanning unit which optically reads an image of an original document and outputs image data corresponding to the read image, and
the second section is an image processing section which processes the image data output from the scanning unit.

12. A control method of an image processing apparatus which includes a first section which outputs image data, an image data bus which transmits the image data output from the first section, and a second section which receives the image data transmitted by the image data bus, the method comprising:
adding data for inspection to the image data output from the first section;
extracting the data for inspection from the image data received by the second section; and
when the extracted data for inspection does not match with predetermined data for inspection, determining that the image data bus is abnormal.
